(19) United States
(12) Patent Application Publication
(10) Pub. No.: US 2005/0275796 A1
(43) Pub. Date: Dec. 15, 2005

(54) Eyeglass assembly including auxiliary eyeglasses secured to primary eyeglasses via magnetic force

(75) Inventor: Hun-Yang Park, Daegu (KR)

Correspondence Address: MAYER, BROWN, ROWE & MAW LLP, 1909 K STREET, N.W., WASHINGTON, DC, 20006, US

(73) Assignee: MULTI VISION, INC.

(21) Appl. No.: 11/119,798

(22) Filed: May 3, 2005

Related U.S. Application Data
(63) Continuation-in-part of application No. 11/091,399, filed on Mar. 29, 2005, now abandoned.

(30) Foreign Application Priority Data
Jun. 12, 2004 (KR) 20-2004-0016513
Oct. 13, 2004 (KR) 10-2004-0081570

(51) Int. Cl. G02C 1/00; G02C 9/00

(52) U.S. Cl. 351/41

(57) ABSTRACT

An eyeglass assembly that includes primary eyeglasses, main magnets mounted on an upper portion of a rim on each side of the primary eyeglasses, and auxiliary magnets mounted on another portion of the primary eyeglasses. The eyeglass assembly also includes auxiliary eyeglasses openably securable to the primary eyeglasses with corresponding main magnets located in an upper portion of the rim on each side of the auxiliary eyeglasses and corresponding auxiliary magnets mounted on the another portion of the auxiliary eyeglasses. Fixing members for housing the corresponding main magnets and auxiliary fixing members for housing the corresponding auxiliary magnets are also provided. In embodiments, the main magnets and the corresponding main magnets generate a magnetic force for securing the auxiliary eyeglasses to the primary eyeglasses in the open position.

This is a Continuation-In-Part of application Ser. No. 11/091,399 filed Mar. 29, 2005.

### BACKGROUND OF THE INVENTION

1. Field of the Invention

The present invention relates generally to an eyeglass assembly. More specifically, the present invention relates to an eyeglass assembly including auxiliary eyeglasses openably secured to primary eyeglasses via magnetic force.

2. Description of Related Art

Conventionally, there have been various proposed method for securing auxiliary eyeglasses to primary eyeglasses. For example, securing clips is one such method that has been proposed and implemented for some time. Magnetic force is another such method that has been used for this purpose. Specifically, auxiliary eyeglasses are secured to the primary eyeglasses with magnets. These magnets, attract each other and are mounted within connecting portions or bridges of the auxiliary and primary eyeglasses with each other.

This method for securing the auxiliary eyeglasses to the primary eyeglasses is effective and can provide a more aesthetically pleasing appearance than other methods of mounting the magnets or other prior art methods for securing auxiliary eyeglasses to primary eyeglasses, such as by using the securing clips discussed above. However, all of these methods have disadvantages. For example, a user of these prior art eyeglasses suffers from an inconvenience of having to separate the auxiliary eyeglasses from the primary eyeglasses when the user no longer wants to use the auxiliary eyeglasses because, the user has to separately take the auxiliary eyeglasses into the user's custody when he or she does not want to use the auxiliary eyeglasses.

Therefore, the user is required to handle the auxiliary eyeglasses which is an inconvenience. Additionally, it is more likely that the user will lose the auxiliary eyeglasses when the user does not want to use auxiliary eyeglasses since they have been separated from the primary eyeglasses and placed some distance from the primary eyeglasses.

Accordingly, a need exists to develop an eyeglass assembly that does not suffer from at least the disadvantages of these prior art eyeglasses. Specifically, it is necessary to develop an eyeglass assembly that is more convenient for the user, while remaining aesthetically pleasing.

### BRIEF SUMMARY OF THE INVENTION

An object of the present invention is to provide an eyeglass assembly having auxiliary eyeglasses secured to primary eyeglasses by means of magnets mounted on auxiliary fixing members or bridges of the primary and auxiliary eyeglasses to enhance the convenience of the eyeglass assembly in use and in custody.

Another object of the present invention is to provide an eyeglass assembly including primary eyeglasses and auxiliary eyeglasses openably secured to the front of the primary eyeglasses. The primary eyeglasses have primary magnets mounted on the bridge of the primary eyeglasses and the auxiliary eyeglasses and auxiliary magnet mounted on the upper central portion of a rim or bridge. The upper portions of the primary eyeglasses and the auxiliary eyeglasses are naturally met with each other to be fixed in place via magnetic force when a user lifts the lower portion of the auxiliary eyeglasses upwardly if the user does not want to use the auxiliary eyeglasses.

Yet another object of the present invention is to provide an eyeglass assembly with the auxiliary eyeglasses secured to the primary eyeglasses by magnets mounted on auxiliary fixing members of the auxiliary eyeglasses and the frame of the primary eyeglasses. The auxiliary eyeglasses can be secured to the upper portion of the primary eyeglasses by mutually attracting magnetic force of the magnets while being opened in front of the primary eyeglasses when a user does not want to use the auxiliary eyeglasses.

Yet another object of the present invention is to provide an eyeglass assembly with auxiliary eyeglasses openably secured to the primary eyeglasses including magnets mounted on auxiliary fixing members, which do not provide additional function, namely, the end pieces and the bridge, so as to lift the auxiliary eyeglasses upwardly from the primary eyeglasses in such a way as to openably secure the auxiliary eyeglasses to the primary eyeglasses, thereby enhancing convenience in use and custody.

Yet another object of the present invention is to provide an eyeglass assembly in which auxiliary eyeglasses are openably secured to the front portion of primary eyeglasses via magnetic force, and which can increase combining force between auxiliary eyeglasses and primary eyeglasses by mounting magnets at side portions of the rim of the primary eyeglasses and at side portions of rim of the auxiliary eyeglasses corresponding to those of the primary eyeglasses.

Yet another object of the present invention is to provide a combining device for an eyeglass assembly in which auxiliary eyeglasses are openably attached to the front portion of primary eyeglasses via magnetic force. The combining device includes main magnets respectively mounted at side portions of the rim of the primary eyeglasses and fixing members respectively protruding inwardly from side portions of the rim of auxiliary eyeglasses to correspond to the main magnets of the primary eyeglasses for coupling the main magnets and the fixing members when the auxiliary eyeglasses are closed and combined with the primary eyeglasses.

### BRIEF DESCRIPTION OF THE DRAWINGS

Additional objects, features, and advantages of the present invention will become apparent from the following detailed description of embodiments of the invention in conjunction with the accompanying drawings where like reference numerals indicate like features, in which:

FIG. 1A and FIG. 1B are perspective views of an eyeglass assembly having auxiliary eyeglasses capable of being fixed on the upper portion of main eyeglasses in accordance with an embodiment of the present invention;

FIG. 2A and FIG. 2B are perspective views of an eyeglass assembly having auxiliary eyeglasses capable of being fixed on the upper portion of primary eyeglasses in accordance with another embodiment of the present invention;

FIG. 3A, FIG. 3B, and FIG. 3C are various views of an eyeglass assembly having auxiliary eyeglasses capable of being fixed on the upper portions and side portions of lens rims of primary eyeglasses in accordance with another embodiment of the present invention;

FIG. 4 is a perspective view of an eyeglass assembly 10 that is substantially similar to the eyeglass assembly of the previous embodiment;

FIG. 5A, FIG. 5B, FIG. 5C, and FIG. 5D are perspective views of an eyeglass assembly having auxiliary eyeglasses capable of being fixed on the upper and lower portions of primary eyeglasses using topbars in accordance with another embodiment of the present invention;

FIG. 6A and FIG. 6B are various views of an eyeglass assembly having auxiliary eyeglasses capable of being fixed at a plurality of locations on primary eyeglasses in accordance with another embodiment of the present invention;

FIG. 7A and FIG. 7B are sectional views of an eyeglass assembly showing an operation state in accordance with another embodiment of the present invention;

FIG. 8 is a perspective view showing an opened and secured state of an eyeglass assembly in accordance with another embodiment of the present invention;

FIG. 9A, FIG. 9B, and FIG. 9C are views of eyeglass assemblies showing uncoupled, closed, and coupled states of an eyeglass assembly in accordance with another embodiment of the present invention;

FIG 10A, FIG. 10B, and FIG. 10C are views of eyeglass assemblies showing uncoupled, closed, and coupled states of an eyeglass assembly in accordance with another embodiment of the present invention;

FIG. 11A, FIG. 11B, and FIG. 11C are views of eyeglass assemblies showing uncoupled, closed, and coupled states of an eyeglass assembly in accordance with another embodiment of the present invention;

FIG. 12A, FIG. 12B, and FIG. 12C are views of eyeglass assemblies showing uncoupled, closed, and coupled states of an eyeglass assembly in accordance with another embodiment of the present invention;

FIG. 13A, FIG. 13B, and FIG. 13C are views of eyeglass assemblies showing uncoupled, closed, and coupled states of an eyeglass assembly in accordance with another embodiment of the present invention;

FIG. 14A, FIG. 14B, and FIG. 14C are views of eyeglass assemblies showing uncoupled, closed, and coupled states of an eyeglass assembly in accordance with another embodiment of the present invention;

FIG. 15A, FIG. 15B, and FIG. 15C are views of eyeglass assemblies showing uncoupled, closed, and coupled states of an eyeglass assembly in accordance with another embodiment of the present invention;

FIG. 16A, FIG. 16B, and FIG. 16C are views of eyeglass assemblies showing uncoupled, closed, and coupled states of an eyeglass assembly in accordance with another embodiment of the present invention; and

FIG. 17A, FIG. 17B, and FIG. 17C are views of eyeglass assemblies showing uncoupled, closed, and coupled states of an eyeglass assembly in accordance with another embodiment of the present invention;

### DETAILED DESCRIPTION OF EMBODIMENTS

Embodiments of the present invention will be described with reference to the accompanying figures.

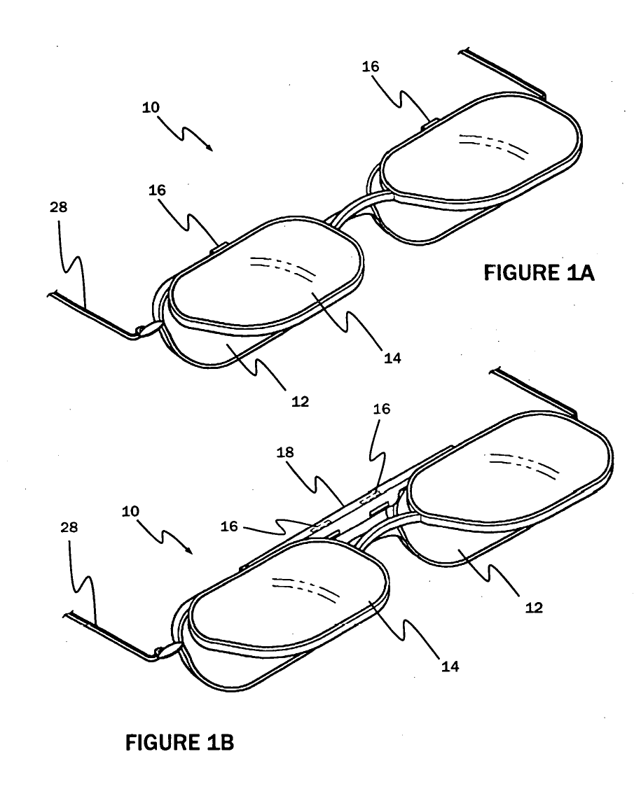

FIG. 1A and FIG. 1B are perspective views of an eyeglass assembly 10 having auxiliary eyeglasses 14 capable of being fixed on the upper portion of main eyeglasses 12. The eyeglass assembly 10 includes primary eyeglasses 12 and auxiliary eyeglasses 14. The primary eyeglasses 12 includes a pair of legs 28 which are not necessary for the auxiliary eyeglasses 14. As illustrated in FIG. 1A, the auxiliary eyeglasses 14 include a pair of magnets 16 located on a top portion of the auxiliary eyeglasses 14. Corresponding magnets 16, are also positioned on a top portion of the primary eyeglasses 12 such that when the auxiliary eyeglasses 14 are brought into close proximity with the primary eyeglasses 12, the magnetic forge generated by the magnets 10 cause the auxiliary eyeglasses 14 to attach to the primary eyeglasses 12. FIG. 1B illustrates the use of a topbar 18 that can be located on auxiliary eyeglasses 14. Magnets 16 are located within the topbar 18 and corresponding magnets 16 are located in the primary eyeglasses 12 such that the magnets 16 located in the primary eyeglasses 12 aligns with the magnets 16 located within the topbar 18. A bridge may also be provided on the primary eyeglasses 12 for convenience.

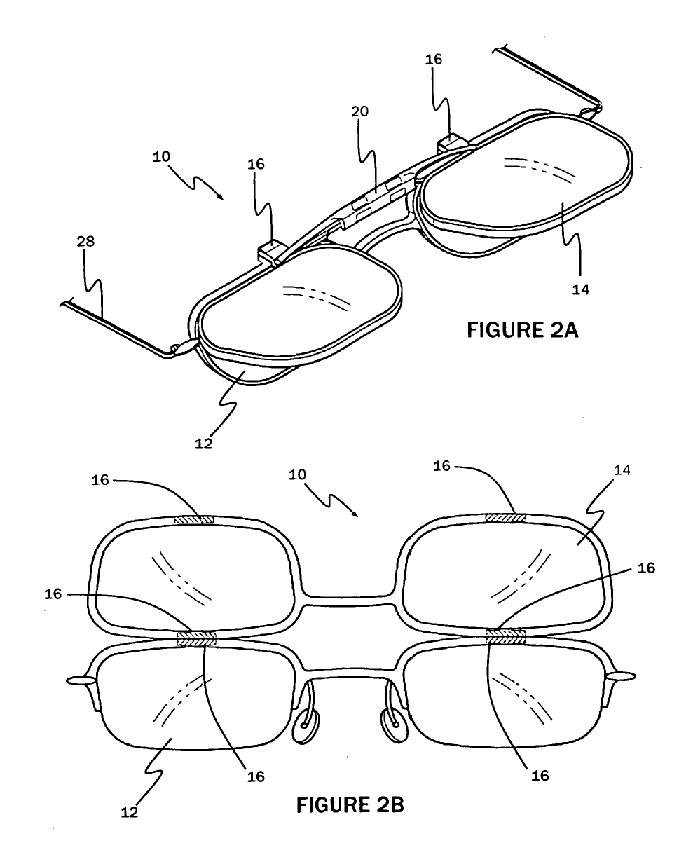

FIG. 2A and FIG. 2B are perspective views of an eyeglasses assembly 10 having auxiliary eyeglasses 14 capable of being fixed on the upper portion of primary eyeglasses 12. As illustrated in FIG. 2A, a connection bar 20, located on the top portion of the auxiliary eyeglasses 14, includes tabs that house magnets 16. Corresponding magnets 16 are also located on tabs on the primary eyeglasses such that the auxiliary eyeglasses 14 align with the primary eyeglasses 12 when the two-are coupled together. FIG. 2B illustrates that magnets 16 can be placed on a front portion of primary eyeglasses 12 and correspondingly on a back surface of the auxiliary eyeglasses 14 aligned with magnets 16 on the primary eyeglasses 12 thereby eliminating the need for connection bar 20.

As may be understood by a person of ordinary skill in the art, the embodiments illustrated in FIGS. 1A, 1B, 2A, and 2B may suffer insufficient magnetic force. It is due to the minimal number of magnets 16 and/or usage of less strong magnets and is also attributed to the fact that the magnets are generally too close to one another. For example, in the embodiments utilizing the topbar 18, the magnets 16 are very close to one another. Therefore, the magnetic force that is generated by each coupling pair of magnets is reduced by the force created by the adjoining pair of magnets 16 located in close proximity to the first pair. Accordingly, in some embodiments, auxiliary magnets may be necessary.

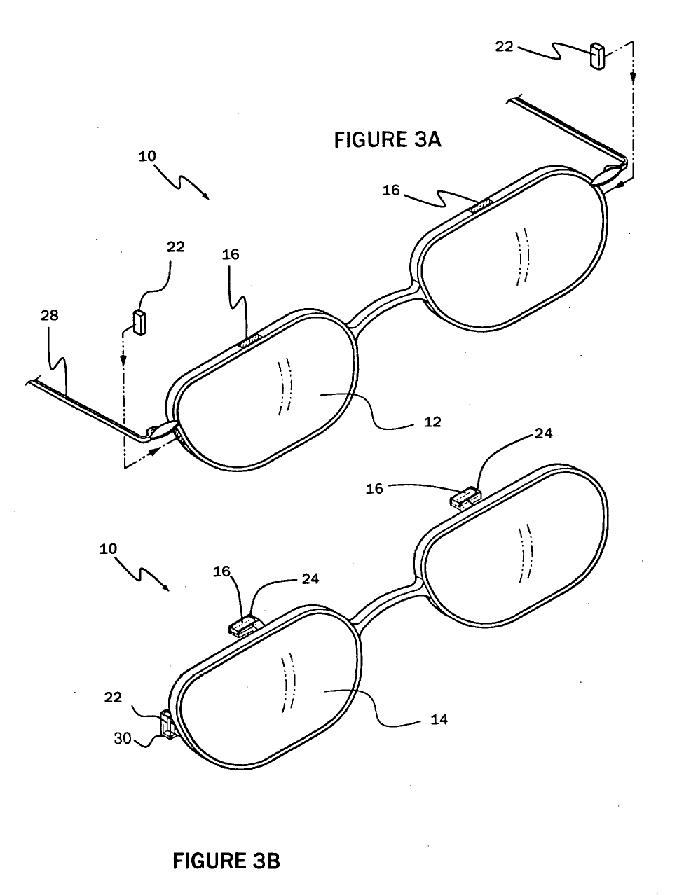

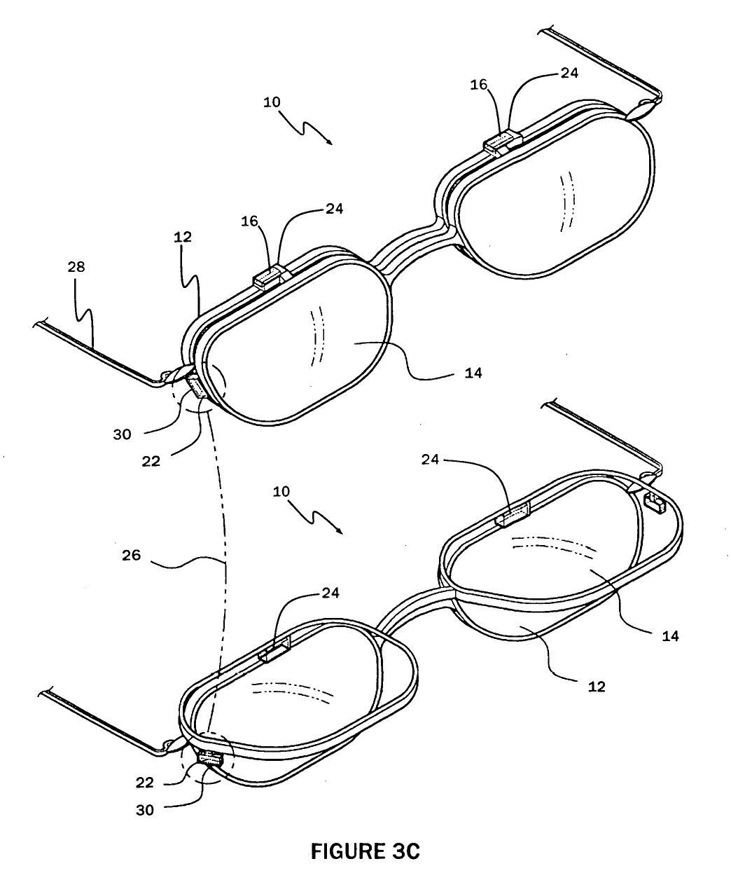

FIG. 3A, FIG. 3B, and FIG. 3C are various views of an eyeglass assembly 10 having auxiliary eyeglasses14 capable of being fixed on the upper portions and side portions of the rims of primary eyeglasses 12 in accordance with another embodiment of the present invention. As shown in these figures, fixing members 24 are positioned on a top location of auxiliary eyeglasses 14 and protrude inwardly from the front face of the auxiliary eyeglasses 14. Magnets 16 are positioned in the fixing members 24 and corresponding magnets 16 are positioned on a top portion of the rim of the primary eyeglasses 12. Although fixing member 24 is illustrated as being a square member, it should be understood that fixing member 24 can be any shape and take any form. For example, as would be understood by a person of ordinary skill in the art, it may be more aesthetically pleasing to integrate the fixing member 24 with the auxiliary eyeglasses 14.

Auxiliary eyeglasses 14 also include auxiliary fixing members 30 located on either side of the auxiliary eyeglasses 14. Auxiliary magnets 22 are located in within the auxiliary fixing member 30 and corresponding auxiliary magnets 22 are located on a side portion of the rim of the primary eyeglasses 12. Additionally, auxiliary fixing members 30 may also be integral with auxiliary eyeglasses 14. In this embodiment, additional magnetic force is achieved and the auxiliary magnets 22 are sufficiently separated from the fixing members 24 so as not to adversely reduce the magnetic force of the magnets 16.

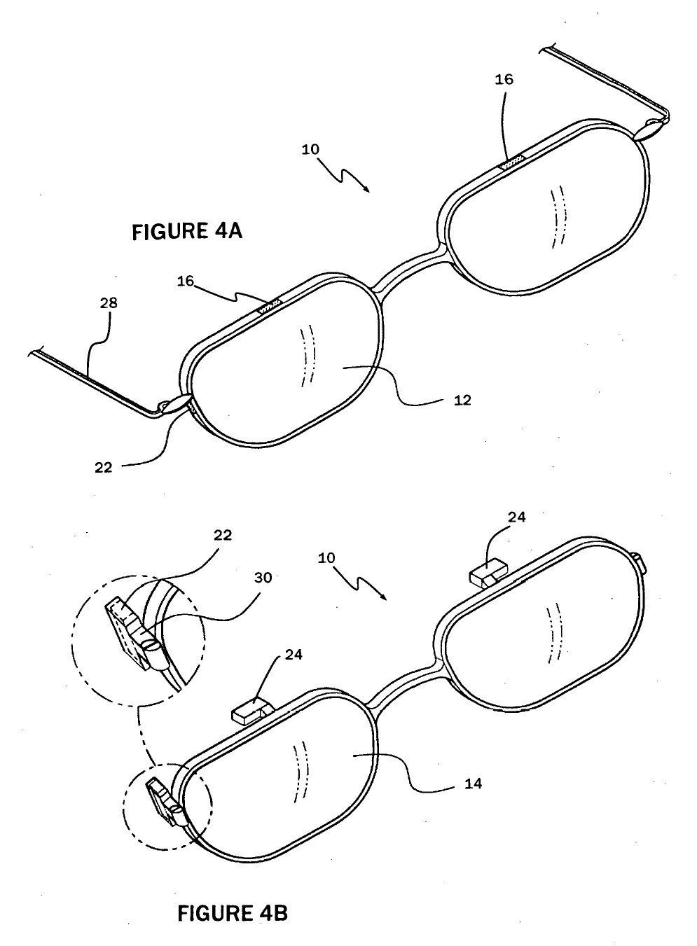

FIG. 4 is a perspective view of an eyeglass assembly 10 that is substantially similar to the eyeglass assembly 10 of the previous embodiment. However, in the embodiment of FIG. 4, the auxiliary fixing member 24 is rotatable such that it can more readily attach to the auxiliary magnets 22 located on the sides of the rim of primary eyeglasses 12.

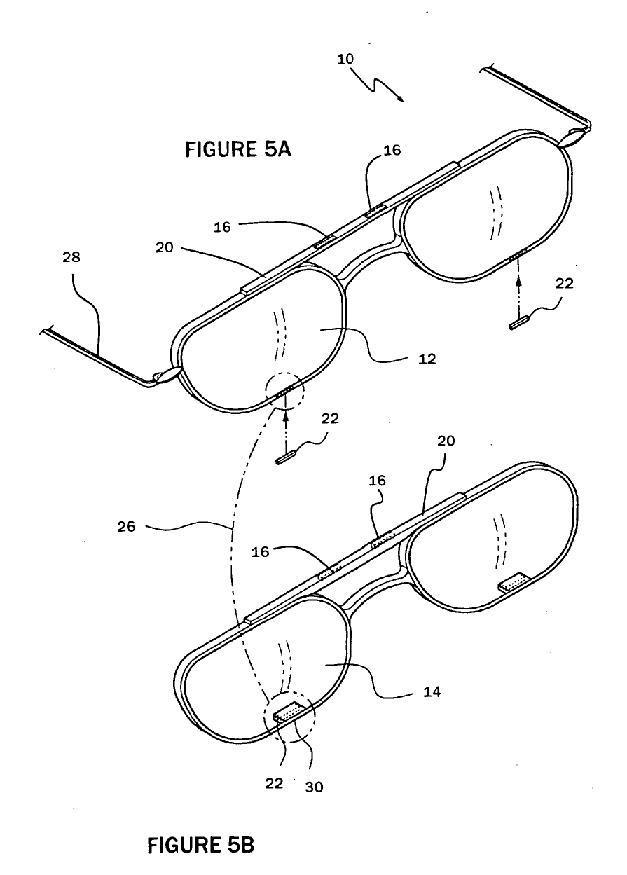

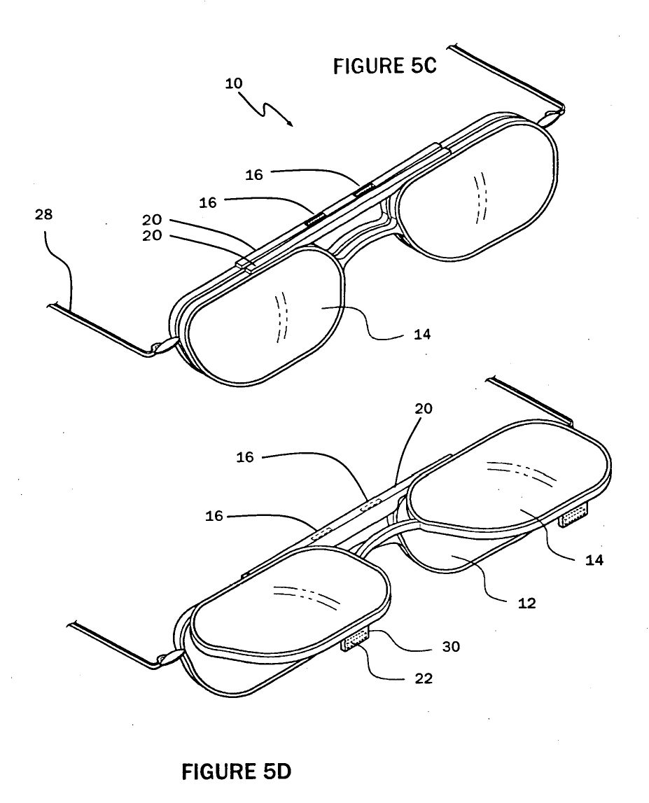

FIG. 5A, FIG. 5B, FIG. 5C, and FIG. 5D are perspective views of an eyeglass assembly 10 having auxiliary eyeglasses 14 capable of being fixed on the upper and lower portions of primary eyeglasses 12 using topbars 18 in accordance with an embodiment of the present invention. As illustrated in FIG. 5, magnets 16 are utilized in topbar 18 in auxiliary eyeglasses 14 and in corresponding locations on primary eyeglasses 12. Additionally, auxiliary eyeglasses 14 also include auxiliary fixing members 30 located on the bottom of the auxiliary eyeglasses 14. Magnets 16 are located within the auxiliary fixing member 30 and corresponding auxiliary magnets 22 are located on a bottom portion of a the rim of the primary eyeglasses 12. Additionally, in embodiments, auxiliary fixing members 30 may also be integral with auxiliary eyeglasses 14.

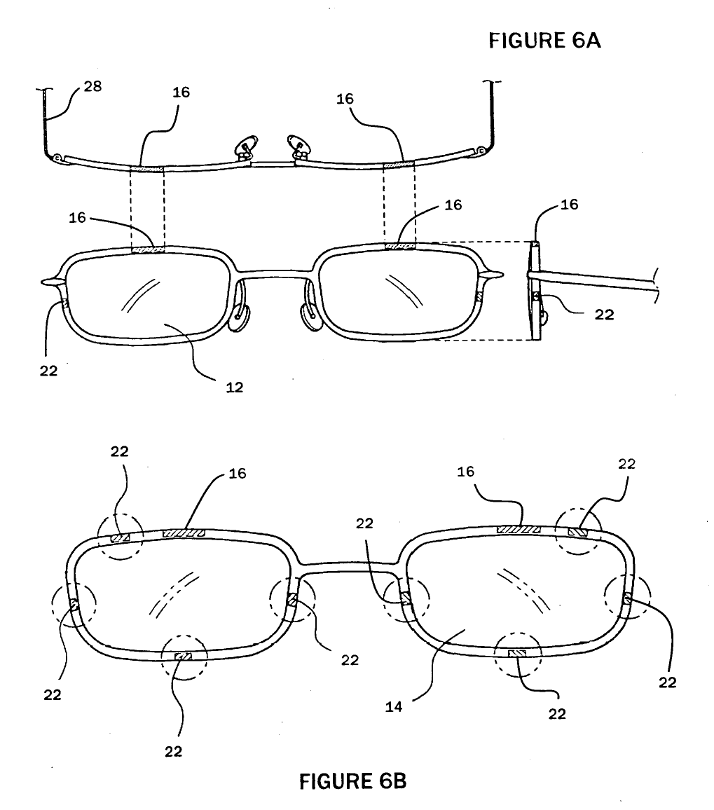

FIG. 6A and FIG. 6B are various views of an eyeglass assembly 10 having auxiliary eyeglasses 14 capable of being fixed at a plurality of locations on primary eyeglasses 12 in accordance with an embodiment of the present invention. As illustrated in these figures, in addition to magnets 16, auxiliary magnets 22 can be located in a plurality of locations around the rim of primary eyeglasses 12. Corresponding auxiliary magnets 22 are located at corresponding locations around the rim of auxiliary eyeglasses 14. As would be understood by a person of ordinary skill in the art, the positions and number of auxiliary magnets 22 can be varied without altering the scope of the present invention. This embodiment, may create an aesthetically pleasing appearance for the eyeglass assembly 10, since no fixing means are required, without substantially reducing the magnetic force between the auxiliary eyeglasses 14 and primary eyeglasses 12.

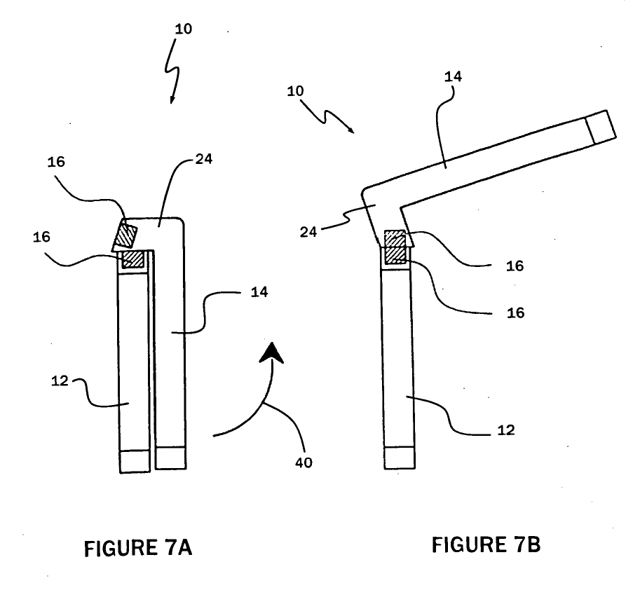

FIG. 7A and FIG. 7B are sectional views of an eyeglass assembly 10 showing an operation state in accordance with an embodiment of the present invention. As illustrated in FIGS. 7A and 7B, the auxiliary eyeglasses 14 a openably secured to the primary eyeglasses 12. In this manner, when a user no longer desires to use the auxiliary eyeglasses 14, the user can simply open the auxiliary eyeglasses 14 with respect to the primary eyeglasses 12 as illustrated by arrow 40. In this manner, it is no longer necessary to separate the auxiliary eyeglasses 14 from the primary eyeglasses 12 when the auxiliary eyeglasses 14 are not in use.

As illustrated in FIGS. 7A and 7B, the eyeglass assembly 10 includes primary eyeglasses 12 provided with magnets 16 mounted on the upper bridge of the primary eyeglasses, and auxiliary eyeglasses 14 provided with corresponding magnets 16 mounted on the upper bridge, fixing member 24, or topbar 18 of the auxiliary eyeglasses 14. If the user does not want to use the auxiliary eyeglasses 14, the user may lift the lower portion of the auxiliary eyeglasses 14 upwardly as indicated by arrow 40, the upper portions of the primary eyeglasses 12 and the auxiliary eyeglasses 14 are naturally met with each other and the auxiliary eyeglasses 14 are lifted upwardly to be opened in front and secured to the primary eyeglasses 12.

The magnets 16 that are embedded in the upper bridge of the primary eyeglasses 12 generate magnetic force and the magnets 16 are also located in a corresponding position on the auxiliary eyeglasses 14. Magnets 16 are located and oriented in such a way that the magnets 16 on the primary eyeglasses 12 and the magnets 16 on the auxiliary eyeglasses 14 do not generate magnetic force or generate little magnetic force with each other when the primary eyeglasses12 and the auxiliary eyeglasses 14 are in the closed position indicated in FIG. 7A. However, they generate a very strong magnetic force when the lower portions of auxiliary eyeglasses 14 are lifted upwardly. More specifically, the magnets 16 located on the auxiliary eyeglasses 14 protrudes from the upper portion of the rim or fixing member 24 of the auxiliary eyeglasses 14 and generates magnetic force toward the rear side of the fixing member 24 of the rim of the auxiliary eyeglasses 14 to generate magnetic force when the auxiliary eyeglasses are lifted upwardly and secured on the primary eyeglasses 12 in the open position as illustrated in FIG. 7B. This configuration allows the primary eyeglasses 12 and auxiliary eyeglasses 14 to openably secured to each other.

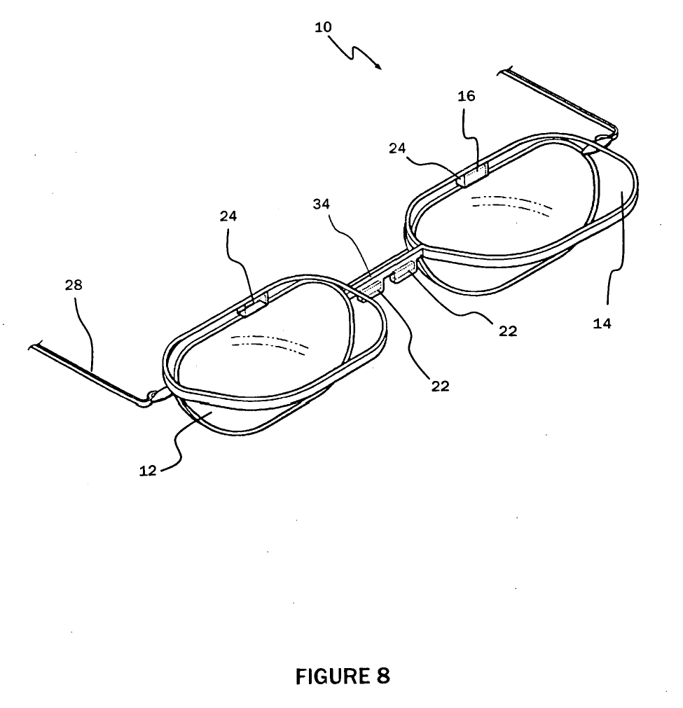

FIG. 8 is a perspective view showing an opened and secured state of an eyeglass assembly 10 in accordance with an embodiment of the present invention. As illustrated, magnets 16 located in fixing members 24 secure the auxiliary eyeglasses 14 to the primary eyeglasses 12. In addition, auxiliary magnets 22 are formed on a bridge 34 of auxiliary eyeglasses 14. As previously described, magnets 16, may not provide substantial magnetic force for coupling the auxiliary eyeglasses 14 to the primary eyeglasses 12 in the closed position. In this case, auxiliary magnets 22 (and corresponding auxiliary magnets 22 located on the primary eyeglasses), provide the magnetic force necessary to secure the auxiliary eyeglasses 14 to primary eyeglasses 12

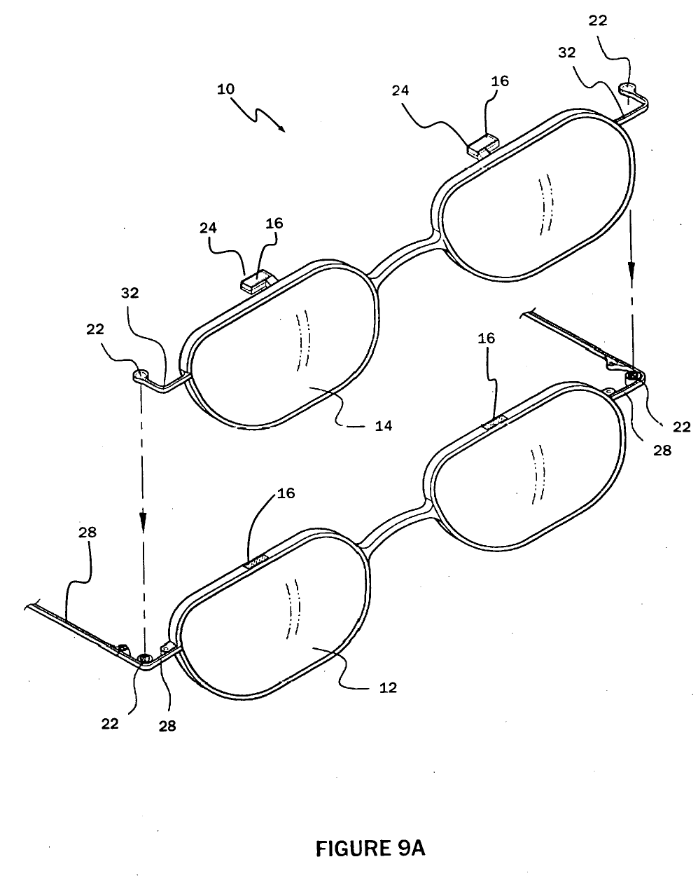

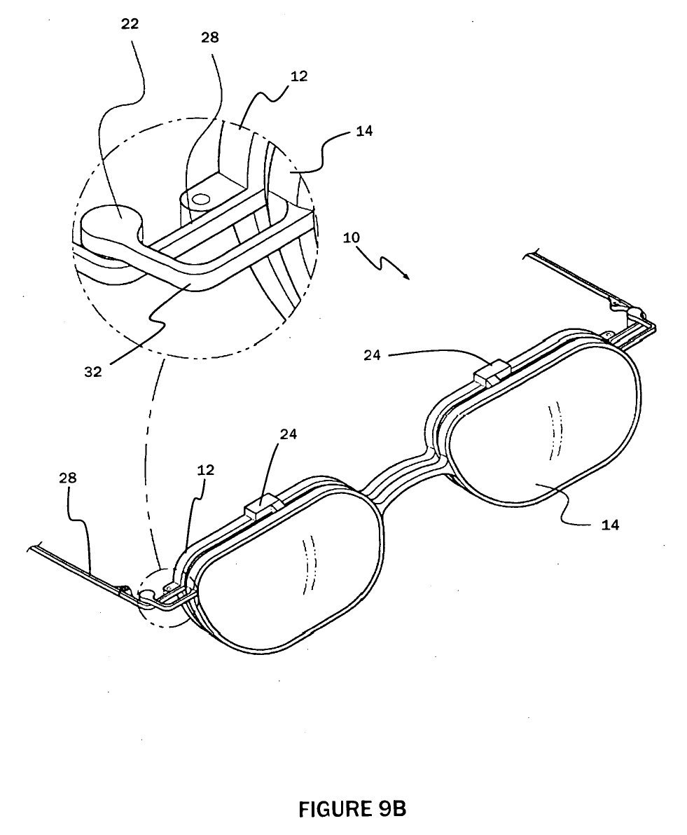

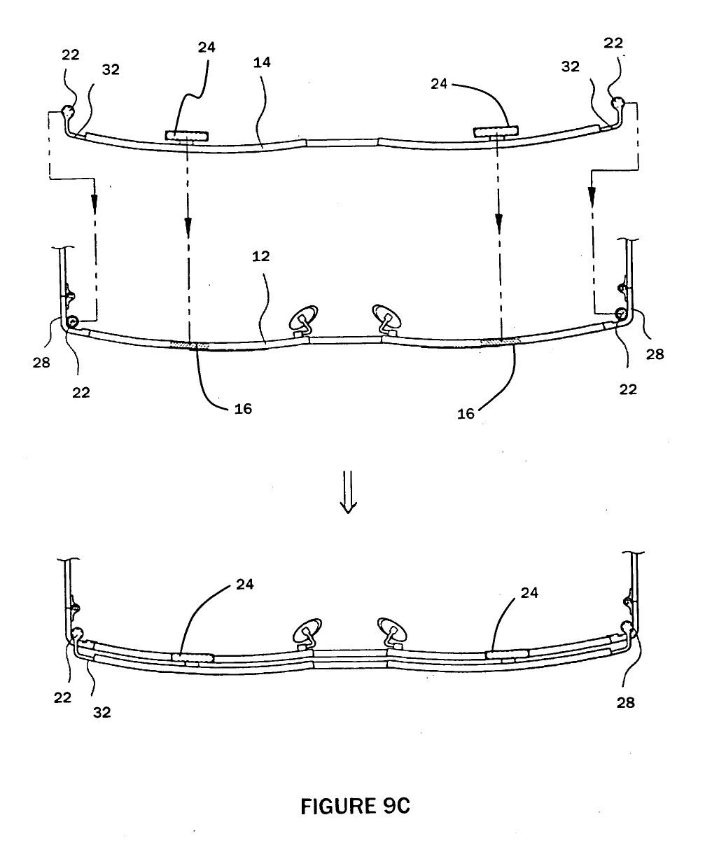

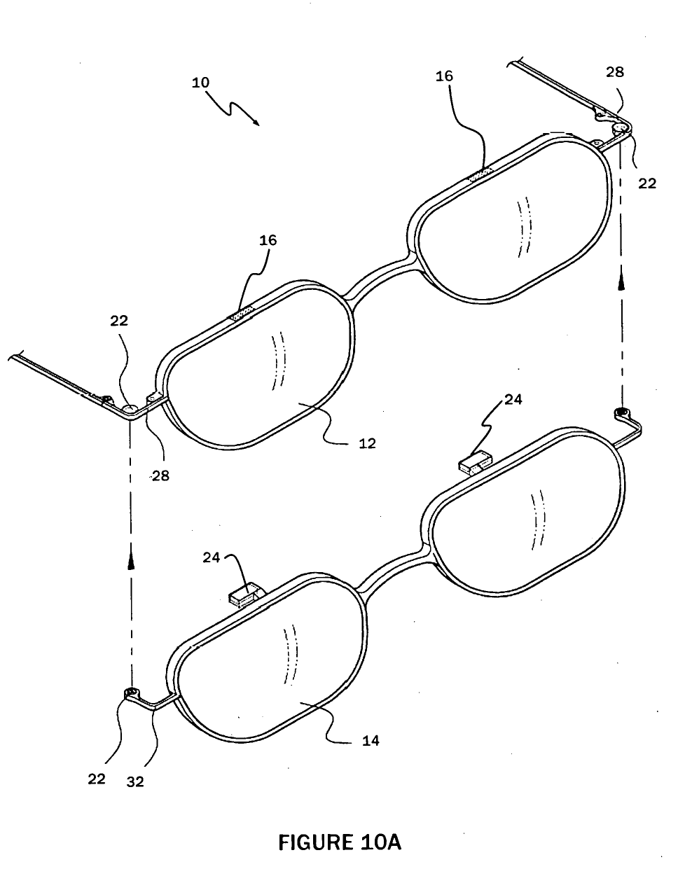

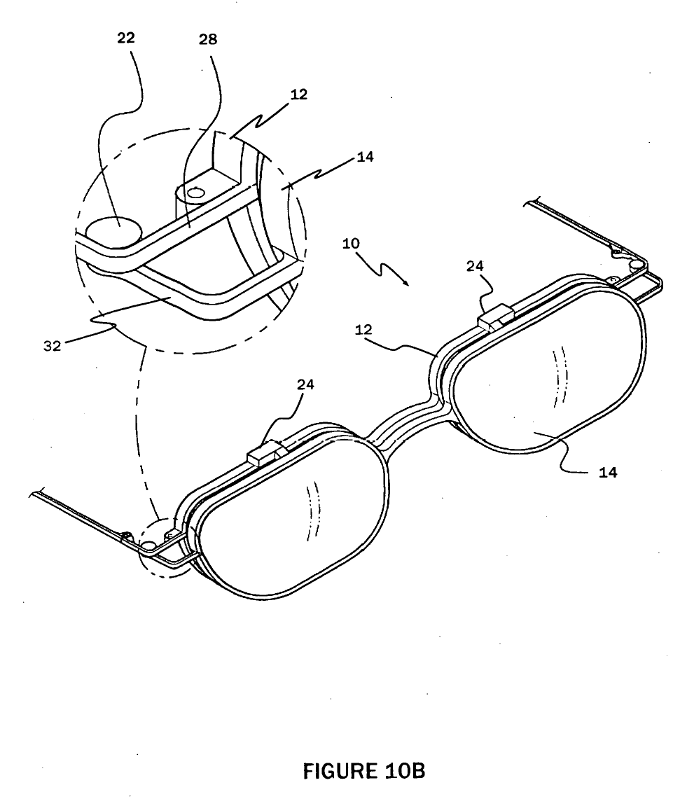

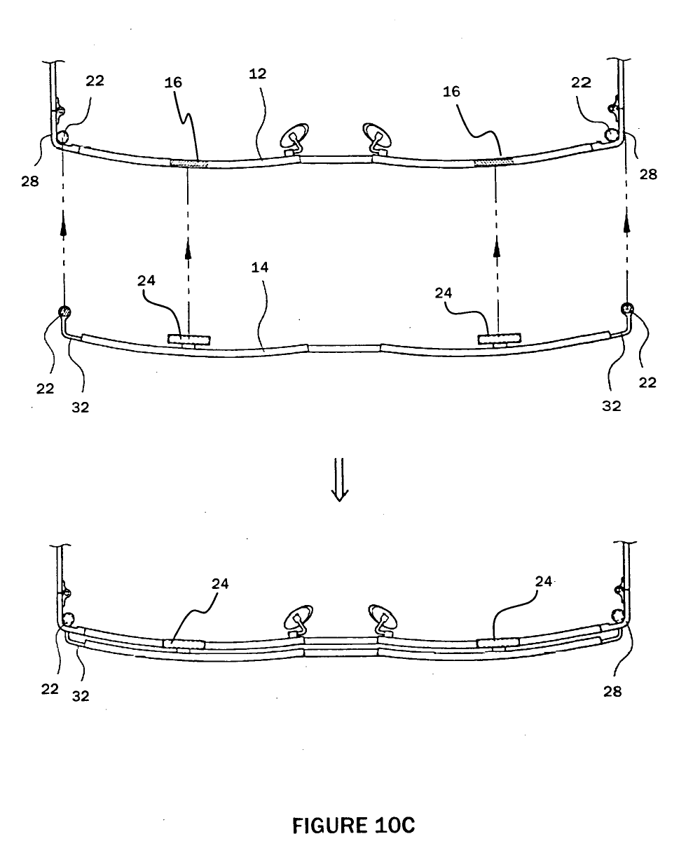

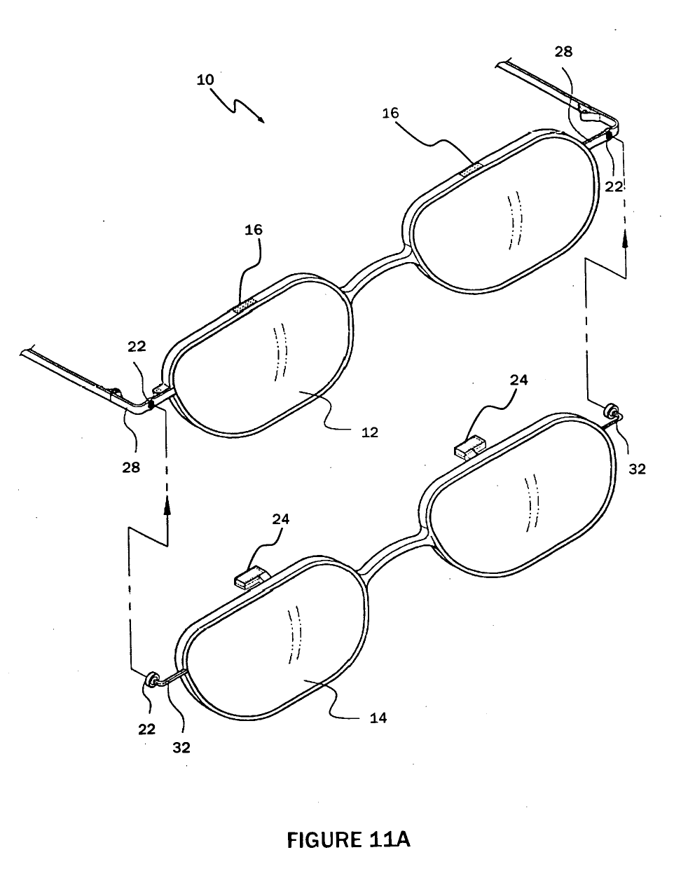

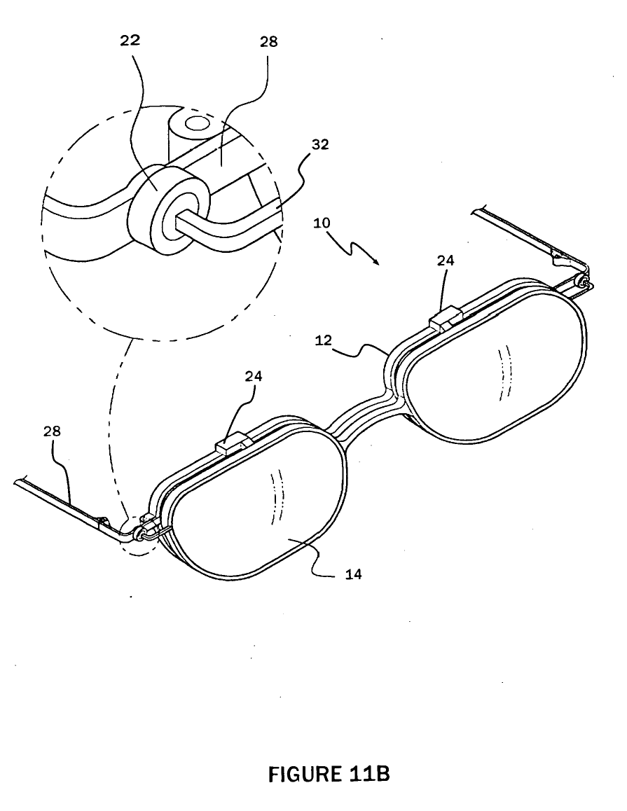

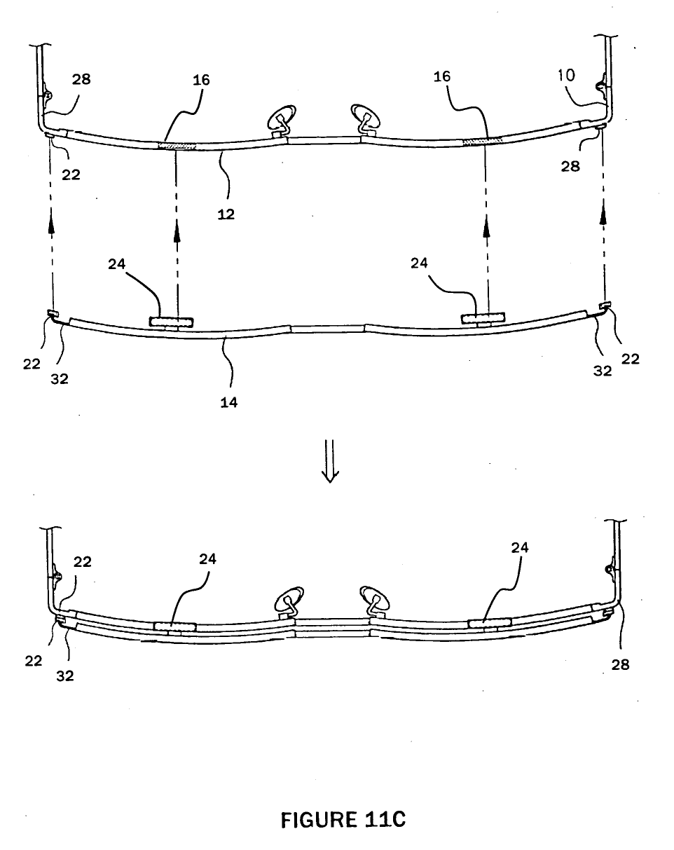

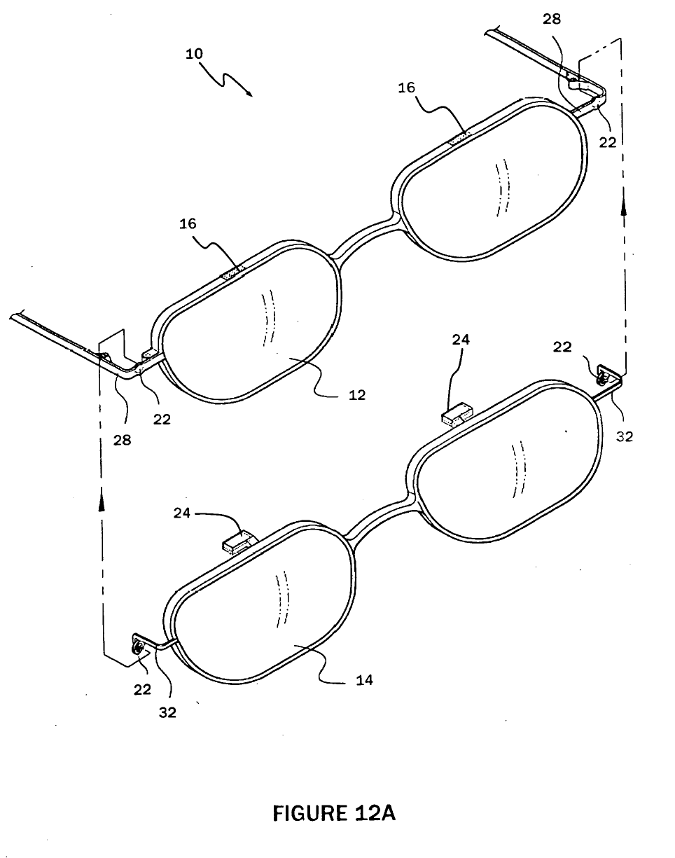

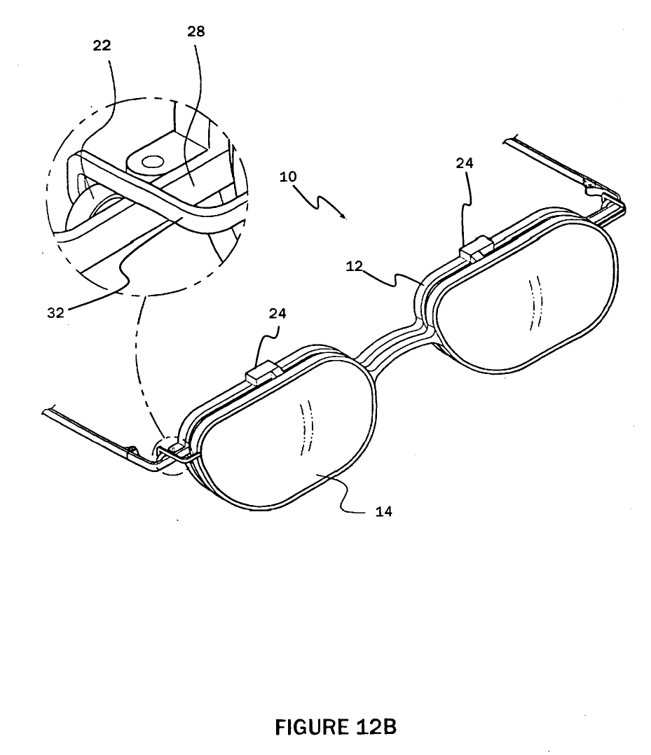

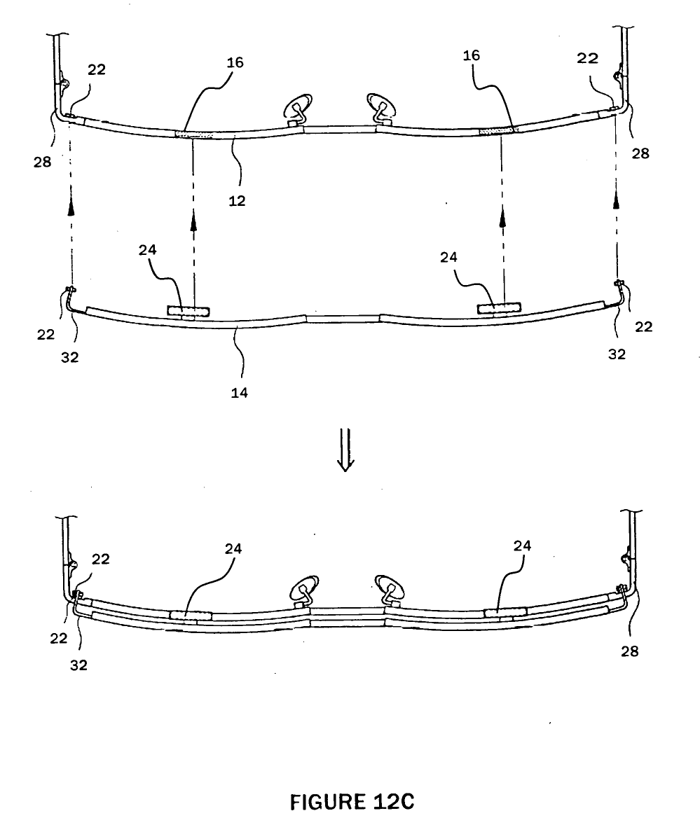

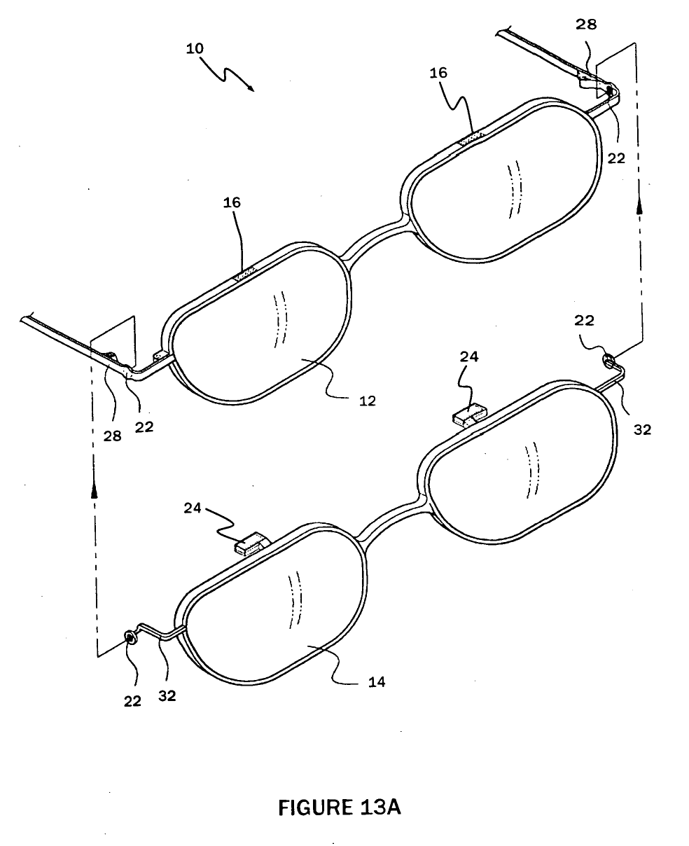

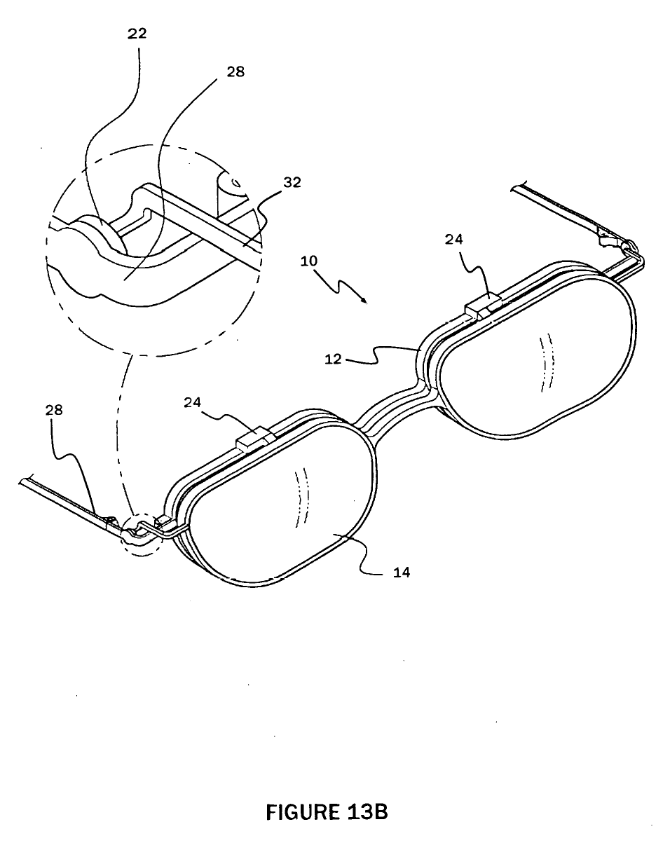

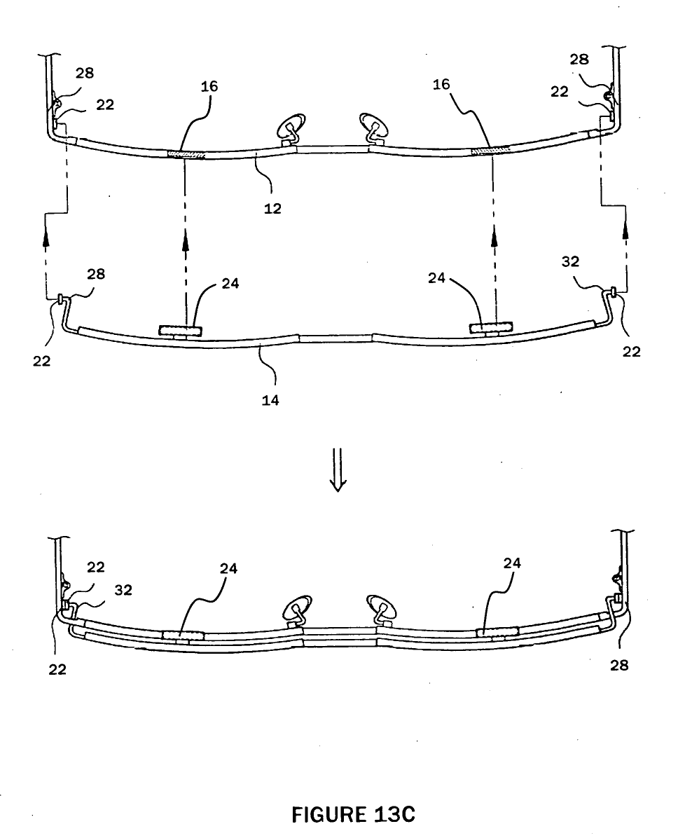

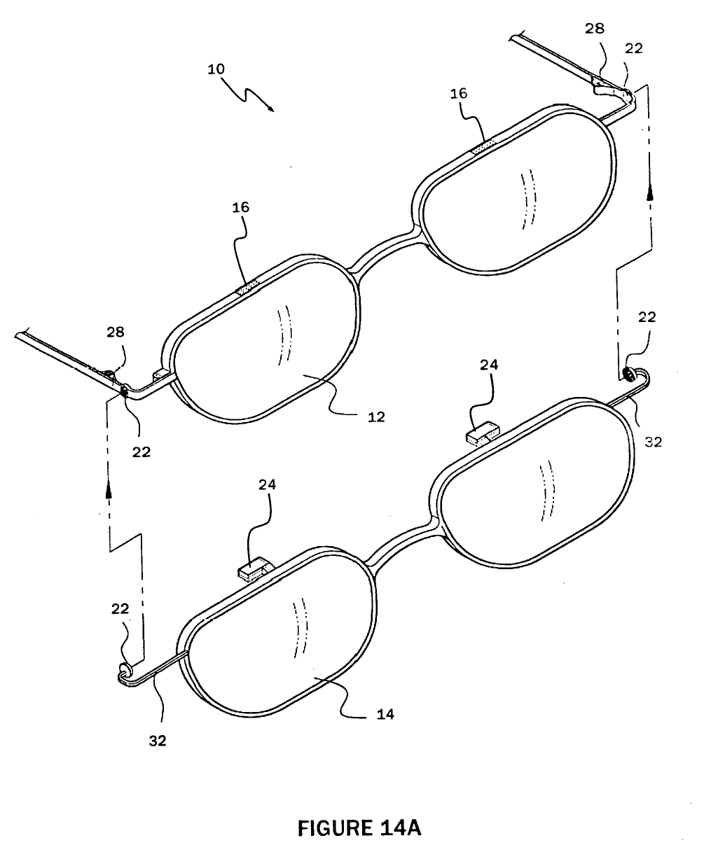

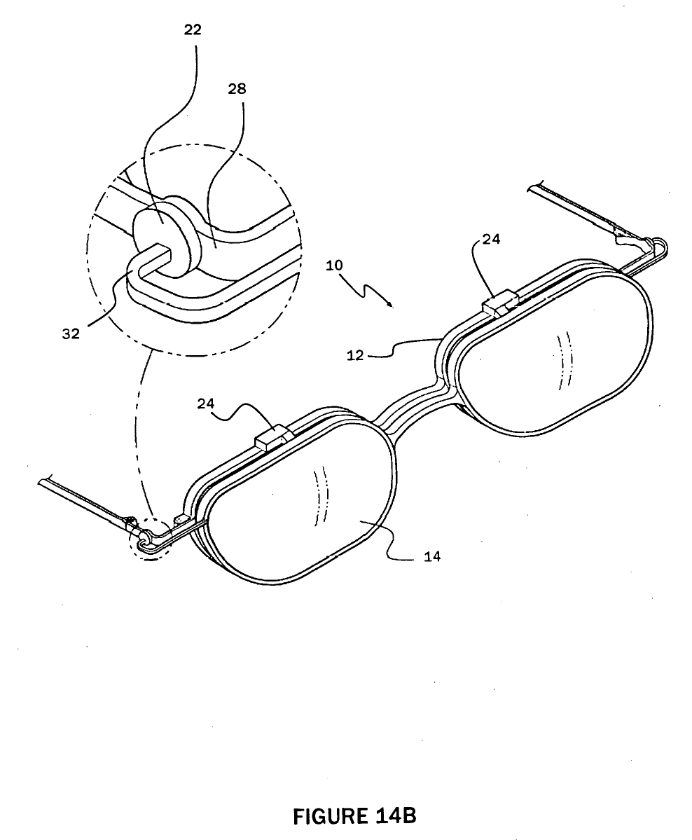

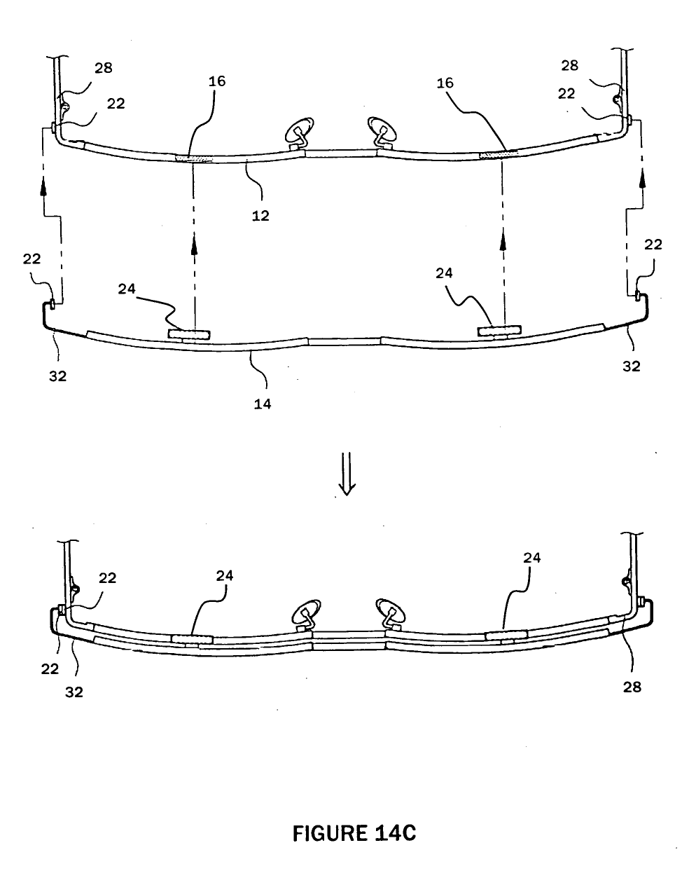

FIGS. 9A-FIG. 14C are views of eyeglass assemblies 10 showing uncoupled, closed, and coupled states of an eyeglass assembly 10 in accordance with other embodiments of the present invention. FIGS. 9-14 illustrate various embodiments for coupling auxiliary eyeglasses 14 to primary eyeglasses 12. Specifically, FIGS. 9A, 9B, and 9C illustrates auxiliary magnets 22 attached to auxiliary fixing members 32 of the auxiliary eyeglasses 14 and corresponding auxiliary magnets 22 located on a leg 28 of the primary eyeglasses 12. The auxiliary eyeglasses 14 can be openably coupled to the primary eyeglasses 12 from the top. In FIGS. 10A, 10B, and 10C the auxiliary eyeglasses can be openably coupled to primary eyeglasses 14 from the bottom. In FIGS. 11A, 11B, and 11C, the auxiliary eyeglasses 14 are coupled to the front of a leg 28 of the primary eyeglasses 12. In FIGS. 12A, 12B, and 12C, the auxiliary eyeglasses 14 are coupled to the back of the front of a leg 28 of the primary eyeglasses 12 via auxiliary magnets 22. In FIGS. 13A, 13B, and 13C, the auxiliary eyeglasses 14 are coupled to the inner sides of a leg 28 of the primary eyeglasses 12 via auxiliary magnets 22 and in FIGS. 14A, 14B, and 14C, the auxiliary magnets 22 are located on the outer sides of legs 28 of the primary eyeglasses 12. As can be readily seen from these drawings, the auxiliary eyeglasses 14 are coupled to primary eyeglasses 12 in such a way that the auxiliary eyeglasses 14 can be easily opened from the closed position to the open position described above. Once in the open position, auxiliary magnets 22 may or may not continue to create magnet force with the corresponding auxiliary magnets 22. In any event, magnets 16 and fixing members 24 create the substantial magnetic force necessary to secure the auxiliary eyeglasses 14 to the primary eyeglasses 12 in the open position.

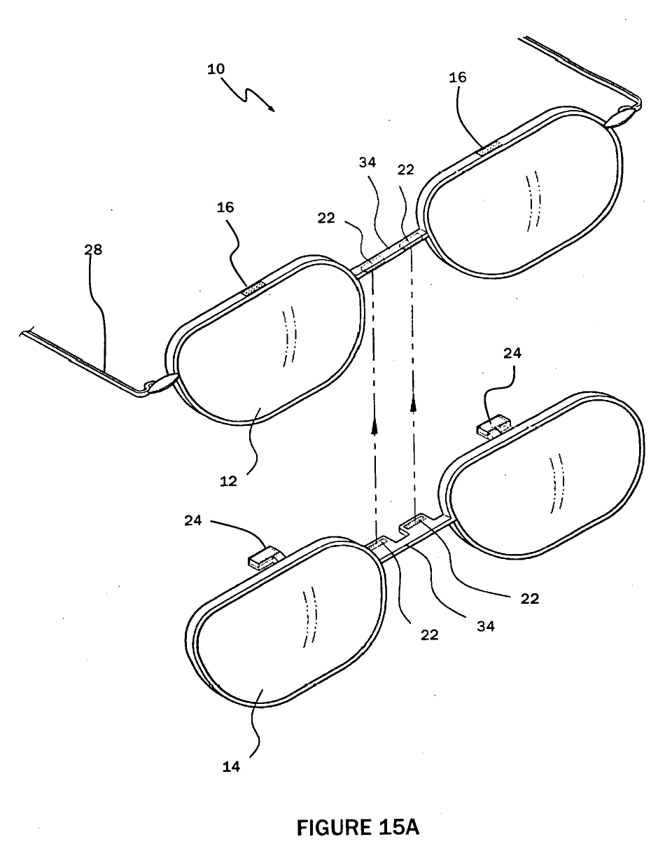

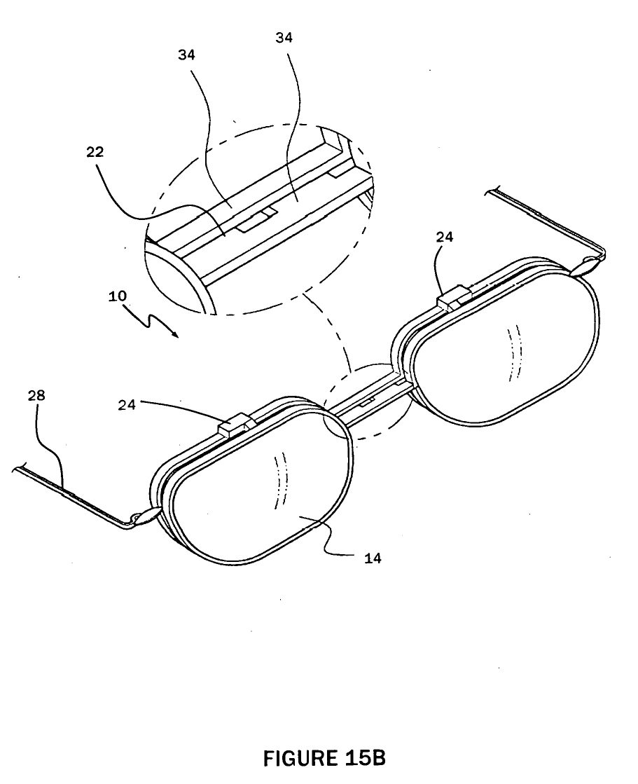

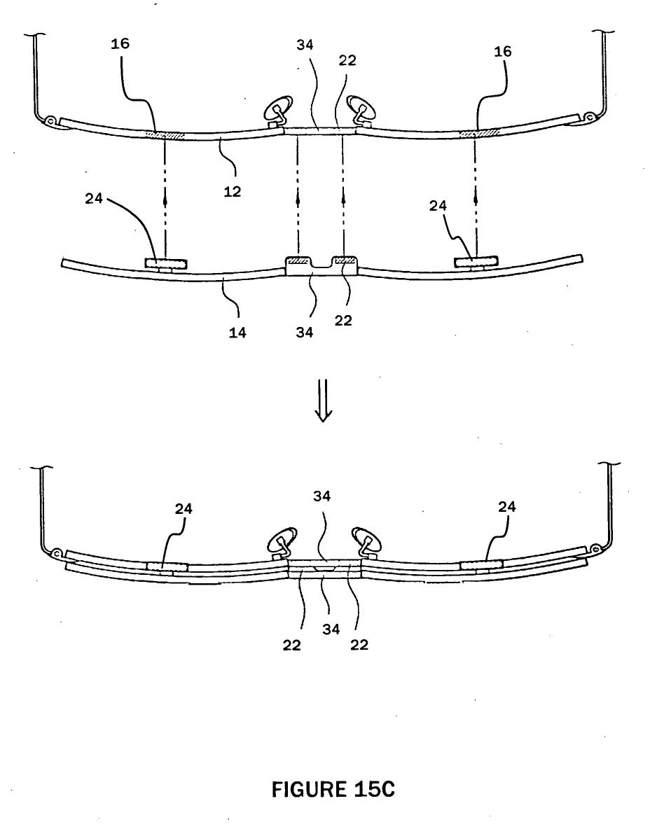

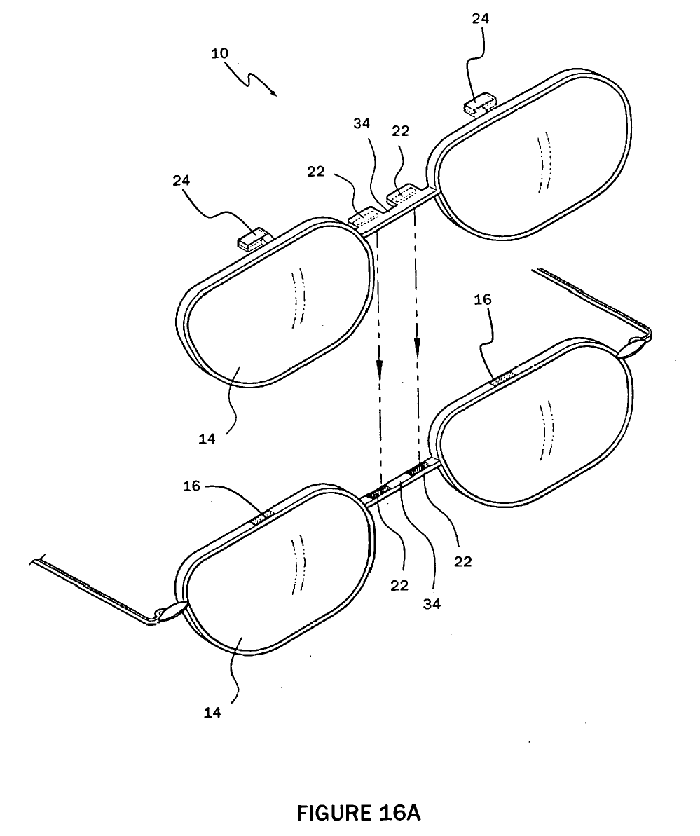

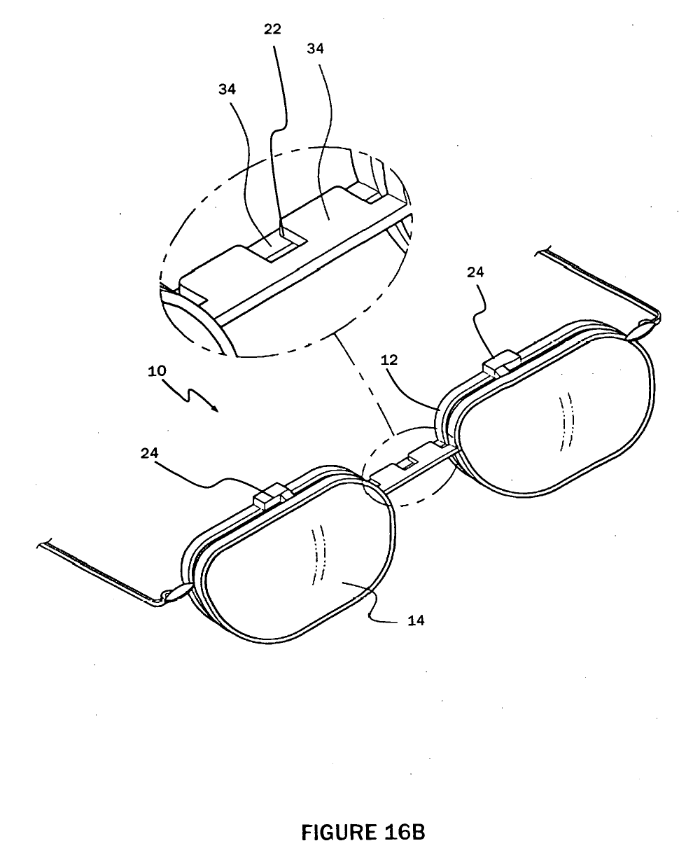

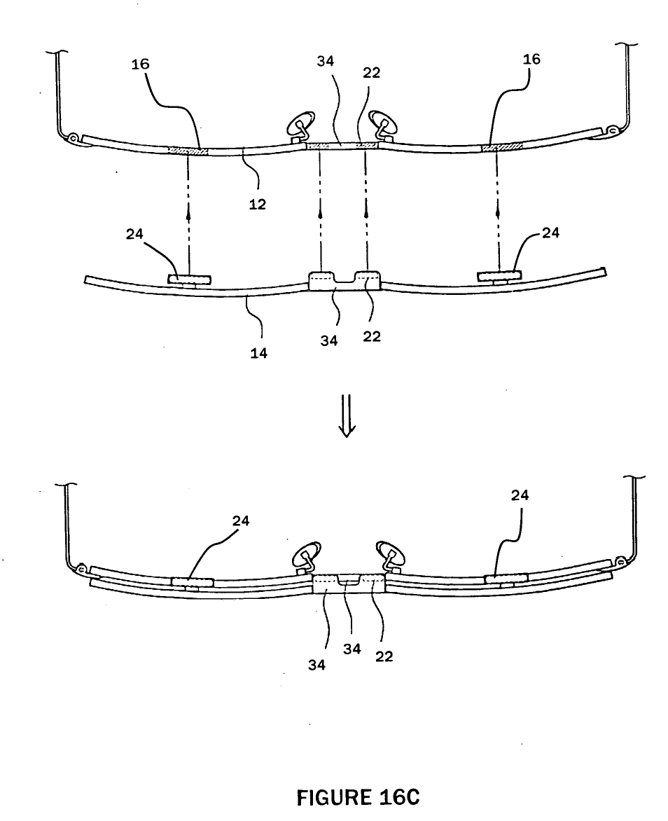

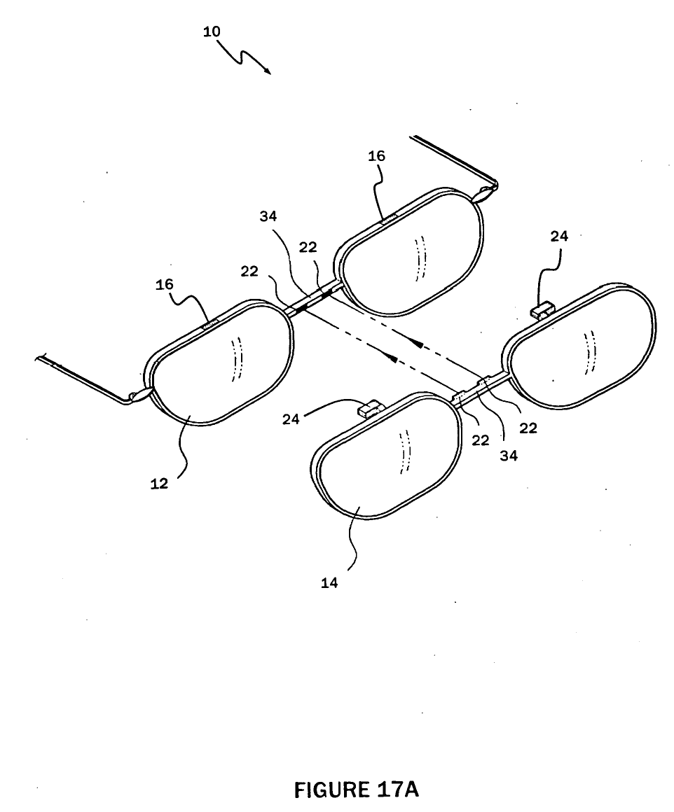

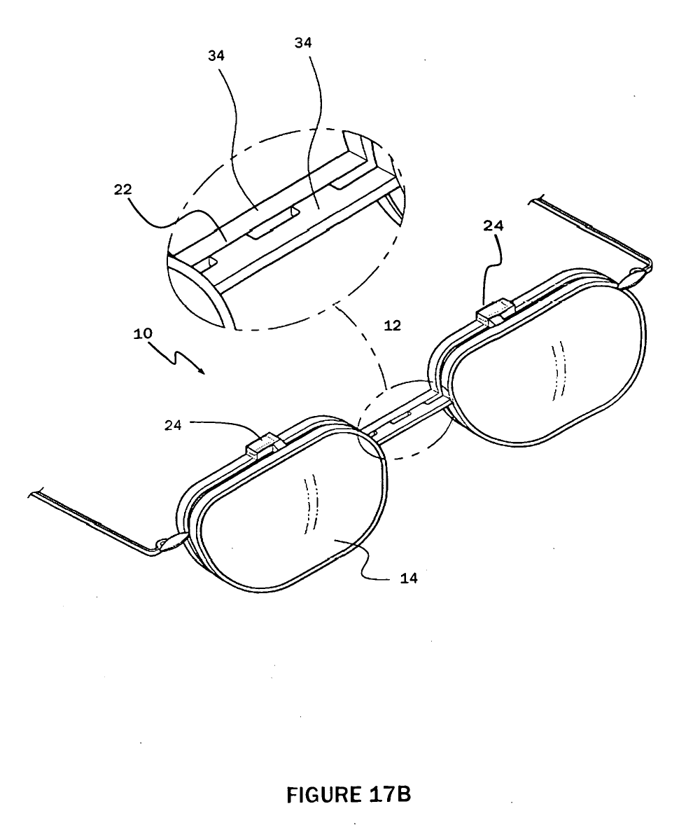

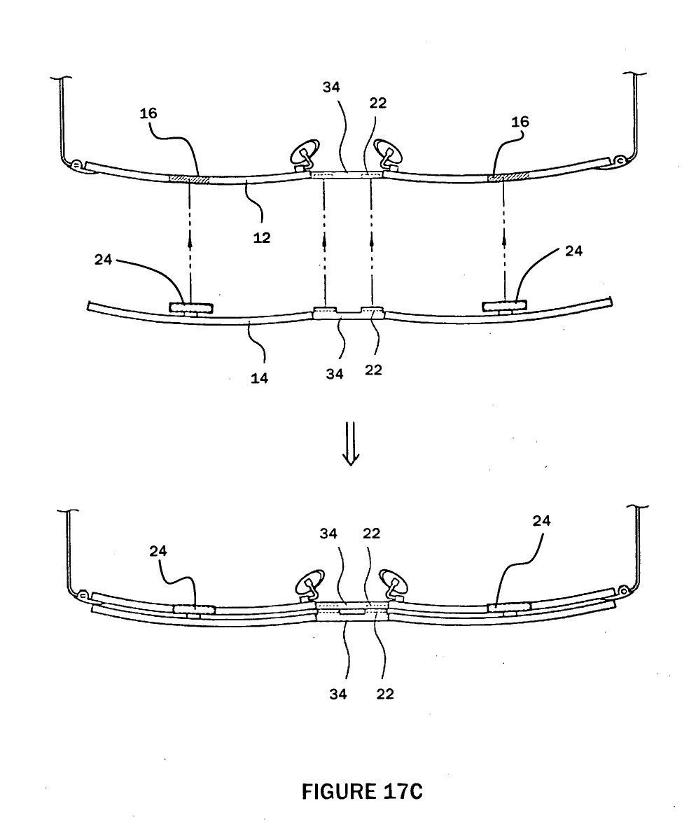

FIG. 15A-FIG. 17C are views of eyeglass assemblies 10 showing uncoupled, closed, and coupled states of an eyeglass assembly 10 in accordance with other embodiments of the present invention. FIGS. 15 illustrate various embodiments for coupling auxiliary eyeglasses 14 to primary eyeglasses 12. Specifically, hese figures illustrate auxiliary magnets 22 attached to a bridge 34 of the auxiliary eyeglasses 14 and corresponding auxiliary magnets 22 located on a bridge 34 of the primary eyeglasses 12. In FIGS. 15A, 15B, and 15C the auxiliary eyeglasses can be openably coupled to primary eyeglasses 14 from the bottom. In FIGS. 16A, 16B, and 16C the auxiliary eyeglasses can be openably coupled to primary eyeglasses 14 from the top and in FIGS. 17A, 17B, and 17C, the auxiliary eyeglasses 14 are coupled to the front of the bridge 34 of the primary eyeglasses 12. As can be readily seen from these drawings, the auxiliary eyeglasses 14 are coupled to primary eyeglasses 12 in such a way that the auxiliary eyeglasses 14 can be easily opened from the closed position to the open position described above. Once in the open position, auxiliary magnets 22 may or may not continue to create magnet force with the corresponding auxiliary magnets 22. In any event, magnets 16 and fixing members 24 create the substantial magnetic force necessary to secure the auxiliary eyeglasses 14 to the primary eyeglasses 12 in the open position.

Many alterations and modifications of the present invention will be comprehended by a person skilled in the art after having read the foregoing description. It is to be understood that the particular embodiments shown and described by way of illustration are in no way intended to be considered limiting. Therefore, references to details of particular embodiments are not intended to limit the scope of the claims.

The embodiments described herein are intended to be illustrative of this invention. As will be recognized by those of ordinary skill in the art, various modifications and changes can be made to these embodiments and such variations and modifications would remain within the spirit and scope of the invention defined in the appended claims and their equivalents. Additional advantages and modifications will readily occur to those of ordinary skill in the art. Therefore, the invention in its broader aspects is not limited to the specific details and representative embodiments shown and described herein.

1. An eyeglass assembly comprising:
primary eyeglasses;
main magnets mounted on an upper portion of a rim on each side of the primary eyeglasses;
auxiliary magnets mounted on another portion of the primary eyeglasses;
auxiliary eyeglasses openably securable to the primary eyeglasses with corresponding main magnets located in an upper portion of a rim on each side of the auxiliary eyeglasses and corresponding auxiliary magnets mounted on another portion of the auxiliary eyeglasses;
fixing members for housing the corresponding main magnets; and
auxiliary fixing members for housing the corresponding auxiliary magnets,
wherein the main magnets and the corresponding main magnets generate a magnetic force for securing the auxiliary eyeglasses to the primary eyeglasses in an open position.

2. The eyeglass assembly of claim 1, wherein the auxiliary fixing members are located on a bridge of the auxiliary eyeglass assembly.

3. The eyeglass assembly of claim 1, wherein the auxiliary fixing members are located on an outer side portion of the rim of the auxiliary eyeglass assembly.

4. The eyeglass assembly of claim 1, wherein the auxiliary fixing members extend laterally and then toward the primary eyeglasses.

5. The eyeglass assembly of claim 4, wherein the auxiliary magnets are located on a front portion of a frame of the primary eyeglasses.

6. The eyeglass assembly of claim 4, wherein the auxiliary magnets are located on a rear portion of a frame of the primary eyeglasses.

7. The eyeglass assembly of claim 4, wherein the auxiliary magnets are located on an outer or inner side portion of a frame of the primary eyeglasses.

8. An eyeglass assembly comprising:
primary eyeglasses;
main magnets mounted on an upper portion of a rim on each side of the primary eyeglasses;
auxiliary magnets mounted on another portion of a rim on each side of the primary eyeglasses;
auxiliary eyeglasses openably securable to the primary eyeglasses with corresponding main magnets located in an upper portion of the rim on each side of the auxiliary eyeglasses and corresponding auxiliary magnets mounted on the other portion of the rim on each side of the auxiliary eyeglasses;
fixing members for housing the corresponding main magnets; and
auxiliary fixing members for housing the corresponding auxiliary magnets,
wherein the main magnets and the corresponding main magnets generate a magnetic force for securing the auxiliary eyeglasses to the primary eyeglasses in an open position; and
wherein the auxiliary magnets and the corresponding auxiliary magnets generate a magnetic force for securing the auxiliary eyeglasses to the primary eyeglasses in a closed position.

9. The eyeglass assembly of claim 8, wherein the auxiliary fixing members are located on a bridge of the auxiliary eyeglass assembly.

10. The eyeglass assembly of claim 8, wherein the auxiliary fixing members are located on an outer side portion of the rim of the auxiliary eyeglass assembly.

11. The eyeglass assembly of claim 8, wherein the auxiliary fixing members extend laterally and then toward the primary eyeglasses.

12. The eyeglass assembly of claim 11, wherein the auxiliary magnets are located on a front portion of a frame of the primary eyeglasses.

13. The eyeglass assembly of claim 11, wherein the auxiliary magnets are located on a rear portion of a frame of the primary eyeglasses.

14. The eyeglass assembly of claim 11, wherein the auxiliary magnets are located on an outer or inner side portion of a frame of the primary eyeglasses.

15. An eyeglass assembly comprising:
auxiliary eyeglasses openably securable to primary eyeglasses with main magnets located in an upper portion of the rim on each side of the auxiliary eyeglasses and auxiliary magnets mounted on the other portion of the rim on each side of the auxiliary eyeglasses;
fixing members for housing the main magnets; and
auxiliary fixing members for housing the auxiliary magnets,
wherein the main magnets generate a magnetic force for securing the auxiliary eyeglasses to the primary eyeglasses in an open position; and
wherein the auxiliary magnets generate a magnetic force for securing the auxiliary eyeglasses to the primary eyeglasses in a closed position.

16. The eyeglass assembly of claim 15, wherein the auxiliary fixing members are located on a bridge of the auxiliary eyeglass assembly.

17. The eyeglass assembly of claim 15, wherein the auxiliary fixing members are located on an outer side portion of the rim of the auxiliary eyeglass assembly.

18. The eyeglass assembly of claim 15, wherein the auxiliary fixing members extend laterally and then toward the primary eyeglasses.

19. The eyeglass assembly of claim 18, wherein the auxiliary magnets are configured to create magnetic force with magnets located on a front or rear portion of a frame of the primary eyeglasses.

20. The eyeglass assembly of claim 18, wherein the auxiliary magnets are configured to create magnetic force with magnets located on an outer or inner side portion of a frame of the primary eyeglasses.

21. An eyeglass assembly comprising:
primary eyeglasses;
main magnets mounted on an upper portion of a rim on each side of the primary eyeglasses;
auxiliary eyeglasses openably securable to the primary eyeglasses with corresponding main magnets located in an upper portion of a rim on each side of the auxiliary eyeglasses; and
fixing members for housing the corresponding main magnets,
wherein the main magnets and the corresponding main magnets generate a magnetic force for securing the auxiliary eyeglasses to the primary eyeglasses in an open position.
